(19) United States
(12) Patent Application Publication
(10) Pub. No.: US 2015/0187292 A1
(43) Pub. Date: Jul. 2, 2015

(54) THIN FILM TRANSISTOR ARRAY PANEL AND DISPLAY DEVICE

(71) Applicant: Samsung Display Co., Ltd., Yongin-City (KR)

(72) Inventor: Young-Su KIM, Nam-gu (KR)

(21) Appl. No.: 14/526,937

(22) Filed: Oct. 29, 2014

(30) Foreign Application Priority Data
Dec. 30, 2013 (KR) 10-2013-0167489

(51) Int. Cl. G09G 3/36

(52) U.S. Cl. CPC G09G 3/3607; G09G 3/3614; G09G 3/3688; G09G 3/3648; G09G 3/3677; G09G 2300/0823; G09G 2300/0478; G09G 2300/0452; G09G 2300/0404; G09G 2310/027; G09G 2310/066; G09G 2320/0233; G09G 2320/0666

(57) ABSTRACT

A thin film transistor array panel includes an array of pixels comprising a first pixel column, a second pixel column that is adjacent to the first pixel column, a first pixel row, and a second pixel row that is adjacent to the first pixel row. The pixels of the first and second pixel columns are connected to a first data line such that a data signal is applied to the pixels of the first and second pixel columns through the first data line, and that, in the first pixel row, the data signal is applied to the pixel of the first pixel column prior to the pixel of the second pixel column, whereas, in the second pixel row, the data signal is applied to the pixel of the second pixel column prior to the pixel of the first pixel column.

### CROSS-REFERENCE TO RELATED APPLICATION

This application claims priority to and the benefit of Korean Patent Application No. 10-2013-0167489 filed in the Korean Intellectual Property Office on Dec. 30, 2013, the entire contents of which are incorporated herein by reference.

### BACKGROUND

1. Field

The described technology generally relates to a thin film transistor array panel and a display device.

2. Description of the Related Art

Currently, flat panel displays have experienced an explosively rapid growth in the market, and display devices are being quickly developed. A flat panel display is a display device that has a thickness that is smaller than the width or length of its screen. Examples of flat panel displays that are widely used include a liquid crystal display (LCD), an organic light emitting diode (OLED) display, and the like.

A display device includes a display panel that includes pixels arranged in a matrix form, and each pixel includes a pixel electrode, a common electrode, and a thin film transistor as a switching element that is connected to each pixel electrode. The thin film transistor is connected to a gate line that transfers a gate signal generated by a gate driver and a data line that transfers a data signal generated by a data driver. The thin film transistor transfers the data signal to the pixel electrode or blocks the data signal according to the gate signal. Each pixel of the display device displays primary colors such as red, green, and blue, and the primary colors of each pixel may be displayed by disposing a color filter or an emission layer emitting light of an intrinsic color on a region corresponding to each pixel.

Meanwhile, in the case of the liquid crystal display, an electric field is generated on a liquid crystal layer by applying a voltage across the pixel electrode and common electrode. In order to prevent a degradation phenomenon generated due to a prolonged application of the electric field in a single direction to the liquid crystal layer, the polarity of the data voltage with respect to the common voltage for each frame, each row, or each pixel is inverted.

The gate driver and the data driver of the display device are generally formed of a plurality of driver IC chips, and since the data driver IC chip is more expensive than the gate driver IC chip, it is desirable to decrease the number of data driver IC chips. When the number of the data driving ICs is reduced, the structure and position of the thin film transistors may not be the same in each pixel, and consequently, vertical line blurs may appear when inversion driving is performed.

Further, a purplish phenomenon in which red pixels and blue pixels become brighter than green pixels is generated.

The above information disclosed in this Background section is only for enhancement of understanding of the background of the described technology and therefore it may contain information that does not constitute a prior art already known to a person of ordinary skill in the art.

### SUMMARY

One or more embodiments of the present disclosure may provide a thin film transistor array panel and a display device having the advantage of not having a purplish phenomenon and/or vertical line blurs caused by the irregularity in the structure and position of the thin film transistors across the plurality of pixels.

In one example embodiment, a thin film transistor array panel includes: an array of pixels comprising a plurality of pixel columns and a plurality of pixel rows, the plurality of pixel columns comprising a first pixel column and a second pixel column that is adjacent to the first pixel column, and the plurality of pixel rows comprising a first pixel row and a second pixel row that is adjacent to the first pixel row; a plurality of gate lines configured to transfer a gate signal to the pixels, two of the plurality of gate lines disposed at both sides of each of the plurality of pixel rows and extending in a row direction, respectively; and a plurality of data lines configured to transfer a data signal to the pixels, each of the plurality of data lines disposed between two of the plurality of pixel columns that are adjacent to each other. Pixels in the same pixel column are configured to output the same color. The pixels of the first and second pixel columns are connected to a first one of the plurality of data lines such that a data signal is applied to the pixels of the first and second pixel columns through the first data line, and that, in the first pixel row, the data signal is applied to the pixel of the first pixel column prior to the pixel of the second pixel column, whereas, in the second pixel row, the data signal is applied to the pixel of the second pixel column prior to the pixel of the first pixel column.

In another example embodiment, a thin film transistor array panel includes: a plurality of pixel columns including a plurality of pixels and a plurality of pixel rows; a plurality of pairs of gate lines configured to transfer a gate-on voltage to the pixels; and a plurality of pairs of data lines configured to transfer a data voltage to the pixels, wherein the respective pairs of gate lines are disposed at an upper side and a lower side of the pixel rows, each of the gate lines is disposed per two pixel columns and located between the two pixel columns, one pixel column displays the same color, and the order in which the data voltage is applied to two pixels of one row of the two pixel columns connected to one data line is opposite to the order in which the data voltage is applied to two pixels of a row adjacent to the one row. The application method by which the data voltage is applied in the opposite directions may be repeatedly performed per every two rows, and for two rows, the application order in which the data voltage is applied between the pixel of an odd-numbered row and the pixel of an even-numbered row may be oppositely changed.

A first pixel of a first one of the two pixel columns may be connected to a gate line disposed at an upper side of the pixel column including the first pixel, a second pixel thereof may be connected to a gate line disposed at a lower side of the pixel column including the second pixel, a third pixel thereof may be connected to a gate line disposed at a lower side of the pixel column including the third pixel, and a fourth pixel thereof may be connected to a gate line disposed at an upper side of the pixel column including the fourth pixel. Further, a first pixel of a second one of the two pixel columns may be connected to a gate line disposed at a lower side of the pixel column including the first pixel, a second pixel thereof may be connected to a gate line disposed at an upper side of the pixel column including the second pixel, a third pixel thereof may be connected to a gate line disposed at an upper side of the pixel column including the third pixel, and a fourth pixel thereof may be connected to a gate line disposed at a lower side of the pixel column including the fourth pixel.

The pixel column may be formed of red, green, and blue pixels that are repeated.

The gate voltage may be sequentially applied to the pairs of gate lines from an upper side to a lower side.

The data voltage may alternately have a first polarity and a second polarity while it is applied to the pixel columns connected to a first data line, and the data voltage may alternately have the second polarity and the first polarity while it is applied to the pixel columns connected to a second data line that is next to the first data line.

The first polarity may be opposite to the second polarity.

The first pixel column may be disposed at a right side of the data line.

A gate voltage may be applied to the pairs of gate lines in the order of a second pixel column, a first pixel column, a third pixel column, and a fourth pixel column.

The data voltage may alternately have a first polarity and a second polarity while it is applied to the pixel columns connected to a first data line, and the data voltage may alternately have the second polarity and the first polarity while it is applied to the pixel columns connected to a second data line that is next to the first data line.

In another example embodiment, a display device includes: a gate driver configured to generate a gate signal; a data driver configured to generate a data signal; and a thin film transistor array panel. The thin film transistor array panel includes: an array of pixels comprising a plurality of pixel columns including a plurality of pixels and a plurality of pixel rows, the plurality of pixel columns comprising a first pixel column and a second pixel column that is adjacent to the first pixel column, and the plurality of pixel rows comprising a first pixel row and a second pixel row that is adjacent to the first pixel row; a plurality of pairs of gate lines configured to transfer a gate signal to the pixels, two of the plurality of gate lines disposed at both sides of each of the plurality of pixel rows and extending in a row direction, respectively; and a plurality of pairs of data lines configured to transfer a data signal to the pixels, each of the plurality of data lines disposed between two of the plurality of pixel columns that are adjacent to each other. Pixels in the same pixel column are configured to output the same color, and the pixels of the first and second pixel columns are connected to a first one of the plurality of data lines such that a data signal is applied to the pixels of the first and second pixel columns through the first data line, and that, in the first pixel row, the data signal is applied to the pixel of the first pixel column prior to the pixel of the second pixel column, whereas, in the second pixel row, the data signal is applied to the pixel of the second pixel column prior to the pixel of the first pixel column.

In another example embodiment, a display device includes: a gate driver configured to generate a gate signal; a data driver configured to generate a data signal; and a thin film transistor array panel. The thin film transistor array panel includes: a plurality of pixel columns including a plurality of pixels and a plurality of pixel rows; a plurality of pairs of gate lines configured to transfer a gate-on voltage to the pixels; and a plurality of pairs of data lines configured to transfer a data voltage to the pixels. The respective pairs of gate lines are disposed at an upper side and a lower side of the pixel rows, each of the gate lines is disposed per two pixel columns and located between the two pixel columns, one pixel column displays the same color, and an order in which the data voltage is applied to two pixels of one row of the two pixel columns connected to one data line is opposite to an order in which the data voltage is applied to two pixels of a row adjacent to the one row.

The application method by which the data voltage is applied in the opposite directions may be repeatedly performed per every two rows, and for two rows, the application order in which the data voltage is applied between the pixel of an odd-numbered row and the pixel of an even-numbered row may be oppositely changed.

A first pixel of a first one of the two pixel columns may be connected to a gate line disposed at an upper side of the pixel column including the first pixel, a second pixel thereof may be connected to a gate line disposed at a lower side of the pixel column including the second pixel, a third pixel thereof may be connected to a gate line disposed at a lower side of the pixel column including the third pixel, and a fourth pixel thereof may be connected to a gate line disposed at an upper side of the pixel column including the fourth pixel. Further, a first pixel of a second one of the two pixel columns may be connected to a gate line disposed at a lower side of the pixel column including the first pixel, a second pixel thereof may be connected to a gate line disposed at an upper side of the pixel column including the second pixel, a third pixel thereof may be connected to a gate line disposed at an upper side of the pixel column including the third pixel, and a fourth pixel thereof may be connected to a gate line disposed at a lower side of the pixel column including the fourth pixel.

The pixel column may be formed of red, green, and blue pixels that are repeated.

The gate voltage may be sequentially applied to the pairs of gate lines from an upper side to a lower side.

The data voltage may alternately have a first polarity and a second polarity while it is applied to the pixel columns connected to a first data line, and the data voltage may alternately have the second polarity and the first polarity while it is applied to the pixel columns connected to a second data line that is next to the first data line.

The first polarity may be opposite to the second polarity.

The first pixel column may be disposed at a right side of the data line.

A gate voltage may be applied to the pairs of gate lines in the order of a second pixel column, a first pixel column, a third pixel column, and a fourth pixel column.

The data voltage may alternately have a first polarity and a second polarity while it is applied to the pixel columns connected to a first data line, and the data voltage may alternately have the second polarity and the first polarity while it is applied to the pixel columns connected to a second data line that is next to the first data line.

In a thin film transistor array panel and a display device in accordance with the one or more example embodiments discussed herein, it is possible to remove a purplish phenomenon and vertical line blurs by controlling the order in which the plurality of pixels are charged by a data voltage.

### BRIEF DESCRIPTION OF THE DRAWINGS

FIG. 1 is a block diagram showing a display device including a thin film transistor array panel in accordance with an example embodiment.

FIG. 2 is a graph showing a data voltage and gate voltages in group A1 of FIG. 1.

FIG. 3 is a graph showing a data voltage and gate voltages group A2 of FIG. 1.

FIG. 4 is a graph showing a data voltage and gate voltages in group A3 of FIG. 1.

FIG. 5 is a block diagram showing a display device including a thin film transistor array panel in accordance with a comparative embodiment.

FIG. 6 is a graph showing a data voltage and gate voltages in group C1 of FIG. 5.

FIG. 7 shows the charging amount of a liquid crystal capacitor of each pixel depending on the data voltage polarity while a gate-on voltage is applied.

FIG. 8 is a graph showing a data voltage and gate voltages in group C2 of FIG. 5.

FIG. 9 is a graph showing a data voltage and gate voltages in group C3 of FIG. 5.

FIG. 10 is a block diagram showing a display device including a thin film transistor array panel in accordance with yet another example embodiment.

### DETAILED DESCRIPTION OF THE EMBODIMENTS

Various example embodiments will be described more fully hereinafter with reference to the accompanying drawings. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, a thin film transistor array panel and a display device including the same in accordance with example embodiments will be described with reference to the drawings.

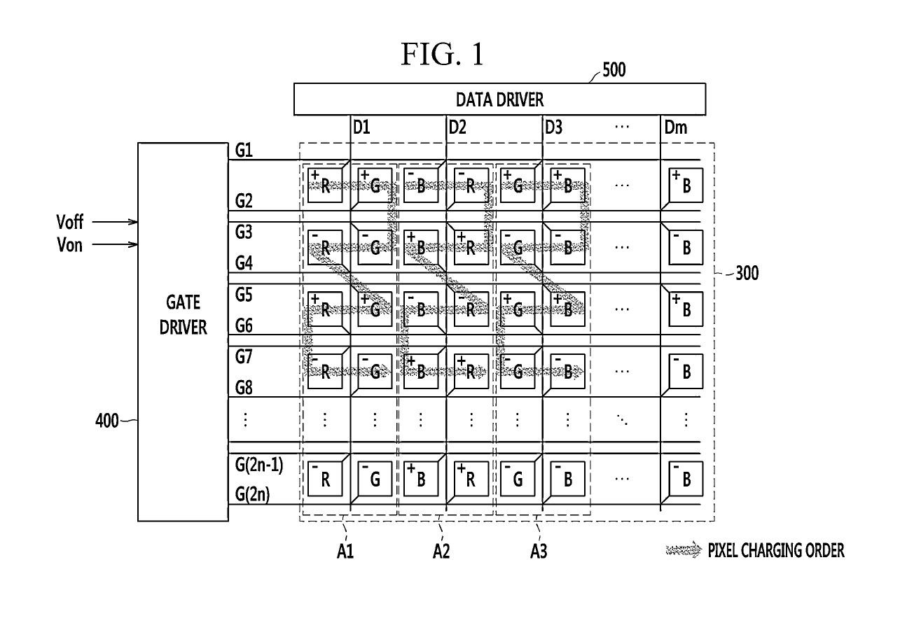

FIG. 1 is a block diagram showing the display device including the thin film transistor array panel in accordance with an example embodiment.

Referring to FIG. 1, the display device according to the example embodiment includes a display panel 300, and a gate driver 400 and a data driver 500 connected thereto.

The display panel 300 includes a plurality of display signal lines G1-G(2n) and D1-Dm, and a plurality of pixels R, G, and B that are connected thereto and arranged substantially in a matrix form.

In an example implementation of color display, each pixel R, G, and B displays one of the primary colors (e.g., red, green, and blue, respectively), and a desired color is represented using a spatial and temporal sum of the primary colors. Examples of the primary colors may include three primary colors such as red, green, and blue.

The display signal lines G1-G(2n) and D1-Dm include a plurality of gate lines G1-G(2n) that transfer gate signals (e.g., referred to as “scanning signal”) and a plurality of data lines D1-Dm that transfer data signals. The gate lines G1-G(2n) extend approximately in a row direction and are substantially parallel to each other, and the data lines D1-Dm extend approximately in a column direction and are substantially parallel to each other. The display signal lines G1-G(2n) and D1-Dm may be formed on a thin film transistor array panel included in the display panel 300.

Further, as shown in the example of FIG. 1, one of the data lines D1-Dm is disposed per two pixel columns. For example, one data line is disposed between a pair of pixels columns.

Further, pairs of gate lines G1 and G2, G3 and G4, etc. are positioned above and below each pixel row, respectively, and pixels R, G, and B in one pixel row are connected to any one of the pairs of gate lines G1 and G2, G3 and G4, etc. adjacent to each other above and below (e.g., in the column direction).

Each of the pixels R, G, and B includes a pixel electrode (not shown) that receives a data signal through a switching element (not shown) such as a thin film transistor (TFT) connected to the gate lines G1-G(2n) and data lines D1-Dm, and a common electrode (not shown) that faces the pixel electrode and receives a common voltage Vcom.

The gate driver 400 is connected to the gate lines G1-G(2n) of the display panel 300 to apply gate signals comprising a combination of a gate-on voltage Von for turning on the switching element and a gate-off voltage Voff for turning off the switching element to the gate lines G1-G(2n). Further, in the present example embodiment, the gate driver 400 may sequentially apply gate signals to the gate lines G1-G(2n). For example, the gate driver 400 may apply gate signals to the gate liens G1-G(2n) in a predetermined sequence or order.

The data driver 500 is connected to the data lines D1-Dm of the display panel 300, and applies the data voltages to the data lines D1-Dm.

Hereinafter, an example arrangement of the pixels R, G, and B will be described in detail with reference to FIGS. 1 through 5. A column of red pixels R displaying a red color, a column of green pixels G displaying a green color, and a column of blue pixels B displaying a blue color are alternately arranged in the row direction of the thin film transistor array panel.

In the example of FIG. 1, one of the data lines D1-Dm is disposed for every two pixel columns in the thin film transistor array panel. For example, one data line is disposed between a pair of pixel columns, the pixels R, G, and B of odd-numbered pixel columns are connected to the data lines D1-Dm directly neighboring at the right side thereof (e.g., as shown in FIG. 1) through the switching element, and the pixels R, G, and B of the even-numbered pixel columns are connected to the data lines D1-Dm directly neighboring at the left side thereof (e.g., as shown in FIG. 1) through the switching element.

In the example of FIG. 1, a first red pixel R of the red pixel columns connected to the data line D1 is connected to the gate line G1 disposed at the upper side thereof, and a second red pixel R is connected to the gate line G4 disposed at the lower side thereof. A third red pixel R is connected to the gate line G6 disposed at the lower side thereof, and a fourth red pixel R is connected to the gate line G7 disposed at the upper side thereof. In a similar manner, the n-th red pixel R is connected to the corresponding gate line.

A first green pixel G of the green pixel columns connected to the data line D1 is connected to the gate line G2 disposed at the lower side thereof, and a second green pixel G is connected to the gate line G3 disposed at the upper side thereof. A third green pixel G is connected to the gate line G5 disposed at the upper side thereof, and a fourth green pixel G is connected to the gate line G8 disposed at the lower side thereof. In a similar manner, the n-th green pixel G is connected to the corresponding gate line.

The pixel column connected to the data line D1 is referred to as group A1, as illustrated in FIG. 1.

The charging of each pixel in A1 is performed in the following order: the first red pixel R of the red pixel column connected to the data line D1, the first green pixel G of the green pixel column connected to the data line D1, the second green pixel G of the green pixel column connected to the data line D1, the second red pixel R of the red pixel column connected to the data line D1, the third green pixel G of the green pixel column connected to the data line D1, the third red pixel R of the red pixel column connected to the data line D1, the fourth red pixel R of the red pixel column connected to the data line D1, and the fourth green pixel G of the green pixel column connected to the data line D1, etc. In a similar manner, the charging is performed until the last pixel connected to the data line D1 is charged.

A first blue pixel R of the blue pixel columns connected to the data line D2 is connected to the gate line G1 disposed at the upper side thereof, and a second blue pixel R is connected to the gate line G4 disposed at the lower side thereof. A third blue pixel B is connected to the gate line G6 disposed at the lower side thereof, and a fourth blue pixel B is connected to the gate line G7 disposed at the upper side thereof. In a similar manner, the n-th blue pixel B is connected to the corresponding gate line.

A first red pixel R of the red pixel columns connected to the data line D2 is connected to the gate line G2 disposed at the lower side thereof, and a second red pixel R is connected to the gate line G3 disposed at the upper side thereof. A third red pixel R is connected to the gate line G5 disposed at the upper side thereof, and a fourth red pixel R is connected to the gate line G8 disposed at the lower side thereof. In a similar manner, the n-th red pixel R is connected to the corresponding gate line.

The pixel column connected to the data line D2 is referred to as group A2.

The charging of each pixel at A2 is performed in the following order: the first blue pixel B of the blue pixel column connected to the data line D2, the first red pixel R of the red pixel column connected to the data line D2, the second red pixel R of the red pixel column connected to the data line D2, the second blue pixel B of the blue pixel column connected to the data line D2, the third red pixel R of the red pixel column connected to the data line D2, the third blue pixel B of the red pixel column connected to the data line D2, the fourth blue pixel B of the blue pixel column connected to the data line D2, the fourth red pixel R of the red pixel column connected to the data line D2, etc. In a similar manner, the charging is performed until the last pixel connected to the data line D2 is charged.

A first green pixel G of the green pixel columns connected to the data line D3 is connected to the gate line G1 disposed at the upper side thereof, and a second green pixel G is connected to the gate line G4 disposed at the lower side thereof. A third green pixel G is connected to the gate line G6 disposed at the lower side thereof, and a fourth green pixel G is connected to the gate line G7 disposed at the upper side thereof. In a similar manner, the n-th blue pixel B is connected to the corresponding gate line.

A first blue pixel B of the blue pixel columns connected to the data line D3 is connected to the gate line G2 disposed at the lower side thereof, and a second blue pixel B is connected to the gate line G3 disposed at the upper side thereof. A third blue pixel B is connected to the gate line G5 disposed at the upper side thereof, and a fourth blue pixel B is connected to the gate line G8 disposed at the lower side thereof. In a similar manner, the n-th blue pixel B is connected to the corresponding gate line.

The pixel column connected to the data line D3 is referred to as group A3.

The charging of each pixel at A3 is performed in the following order: the first green pixel G of the green pixel column connected to the data line D3, the first blue pixel B of the blue pixel column connected to the data line D3, the second blue pixel B of the blue pixel column connected to the data line D3, the second green pixel G of the green pixel column connected to the data line D3, the third blue pixel B of the blue pixel column connected to the data line D3, the third green pixel G of the green pixel column connected to the data line D3, the fourth green pixel G of the green pixel column connected to the data line D3, the fourth blue pixel B of the blue pixel column connected to the data line D3, etc. In a similar manner, the charging is performed until the last pixel connected to the data line D3 is charged.

In the example of FIG. 1, a first pixel of a front pixel column of side pixel columns disposed at opposite sides of the data line (e.g., left side of the data line in FIG. 1) is connected to the gate line disposed at the upper side, and a second pixel thereof is connected to the gate line disposed at the lower side. A third pixel thereof is connected to the gate line disposed at the lower side, and a fourth pixel is connected to the gate line disposed at the upper side.

Further, a first pixel of a back pixel column of the side pixel columns disposed at the opposite sides of the data line (e.g., right side of the data line in FIG. 1) is connected to the gate line disposed at the lower side, and a second pixel thereof is connected to the gate line disposed at the upper side. A third pixel thereof is connected to the gate line disposed at the upper side, and a fourth pixel is connected to the gate line disposed at the lower side.

In a similar manner, a pixel may be located all the way up to the data line Dm.

As a result, when the respective pixels R, G, and B are represented in a matrix form, the thin film transistor array panel of the present example embodiment has a structure in which pixel units (hereinafter referred to as inversion driving units) of a 4×2 size are repeated. For example, the structure of the pixel unit comprising the first eight pixels in group A1 may be repeated throughout the thin film transistor array panel.

The connection relationship among the R, G, and B pixels and display signal lines G1-G(2n) and D1-Dm illustrated in FIG. 1 is merely an example, and the connection relationship and disposition may be changed.

With reference to FIGS. 1 through 4, a pixel charging process in accordance with the present example embodiment will be described.

Referring to FIG. 1, a data voltage (e.g., data signal) of the present example embodiment has a first polarity or a second polarity. In the present example embodiment, when the data voltage is applied to the red pixels R connected to the data line D1, the data voltage alternates between the first polarity and the second polarity, starting with the first row thereof and continuing down the column. When the data voltage is applied to the green pixels G connected to the data line D1, the data voltage alternates between the first polarity and the second polarity, starting with the first row thereof and continuing down the column.

When the data voltage is applied to the blue pixel B connected to the data line D2, the data voltage alternates between the second polarity and the first polarity from the first row thereof. When the data voltage is applied to the red pixel R connected to the data line D2, the data voltage alternates between the second polarity and the first polarity from the first row thereof.

As a result, when the data voltage is applied to the pixels connected to an odd-numbered data line (e.g., data line D1), the data voltage alternates between the first polarity and the second polarity starting from the first row thereof. When the data voltage is applied to the pixels connected to an even-numbered data line (e.g., data line D2), the data voltage alternates between the second polarity and the first polarity starting from the first row thereof.

In the present example embodiment, the first polarity and the second polarity are opposite to each other. For example, when the first polarity is a positive (+) polarity, the second polarity is a negative (−) polarity. When the first polarity is the negative (−) polarity, the second polarity is the positive (+) polarity.

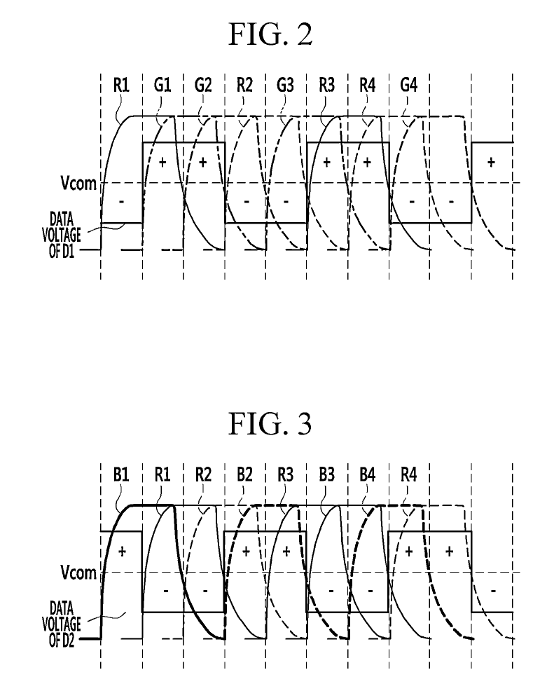

Referring to FIG. 1, the polarity of the data voltage inputted into each pixel is set to the first polarity for two pixels, and to the second polarity for two pixels according to the order in which the pixels are charged. For example, the polarity of the data voltage applied to the data line D1 is shown in FIG. 2.

In the example of FIG. 1, the display device may be a liquid crystal display, and the order in which the data voltage is applied to two pixels of one row of two adjacent pixel columns connected to one data line is opposite to the order in which the data voltage is applied to two pixels of a row adjacent to the one row. For example, for a first pixel column and a second pixel column connected to the data line D1, the data voltage is sequentially applied to two pixels of the first rows in a direction from the pixel of the first pixel column to the pixel of the second pixel column (e.g., left to right in FIG. 1). However, the data voltage is sequentially applied to two pixels of the second rows in the opposite direction, e.g., from the pixel of the second pixel column to the pixel of the first pixel column (e.g., right to left in FIG. 1). This application order in which the data voltage is applied in the opposite directions (e.g., the application method by which the data voltage is applied in the opposite directions) is repeated for every two rows, and for every two rows, the application order in which the data voltage is applied between the pixel of an odd-numbered row and the pixel of an even-numbered row is oppositely changed. For example, in the first two rows, the order may be left to right and then right to left, and in the next two rows, the order may be right to left and then left to right, as shown in FIG. 1.

FIG. 2 is a graph showing a data voltage and a gate voltage at a group A1 of FIG. 1.

R1 indicates a gate voltage waveform of the first red pixel R connected to the data line D1 and the first gate line.

R2 indicates a gate voltage waveform of the second red pixel R connected to the data line D1 and the fourth gate line.

R3 indicates a gate voltage waveform of the third red pixel R connected to the data line D1 and the sixth gate line.

R4 indicates a gate voltage waveform of the fourth red pixel R connected to the data line D1 and the seventh gate line.

G1 indicates a gate voltage waveform of the first green pixel G connected to the data line D1 and the second gate line.

G2 indicates a gate voltage waveform of the second green pixel G connected to the data line D1 and the third gate line.

G3 indicates a gate voltage waveform of the third green pixel G connected to the data line D1 and the fifth gate line.

G4 indicates a gate voltage waveform of the fourth green pixel G connected to the data line D1 and the eighth gate line.

Referring to FIG. 2, a first polarity data voltage is applied during a pre-charging period of the red pixel R1 for one unit of time, and a second polarity data voltage is applied during a main charging period thereof for one unit of time. For the red pixel R2, the first polarity data voltage is applied during both the pre-charging period and the main charging period. For the red pixel R3, the second polarity data voltage is applied during both the pre-charging period and the main charging period. For the red pixel R4, the second polarity data voltage is applied during the pre-charging period, and the first polarity data voltage is applied during the main charging period.

Referring to FIG. 2, for the green pixel G1, the second polarity data voltage is applied during both the pre-charging period and the main charging period thereof. For the green pixel G2, the second polarity data voltage is applied during the pre-charging period and the first polarity data voltage is applied during the main charging period. The first polarity data voltage is applied during the pre-charging period of the green pixel G3, and the second polarity data voltage is applied during a main charging period thereof. The first polarity data voltage is applied during both the pre-charging period and the main charging period of the green pixel G4.

Herein, when the first polarity is a negative (−) polarity, the second polarity is a positive (+) polarity. When the first polarity is the positive (+) polarity, the second polarity is the negative (−) polarity. In one embodiment, the polarity of the data voltage applied during the pre-charging period is opposite to the polarity of the data voltage applied during the main charging period.

FIG. 3 is a graph showing a data voltage and a gate voltage at a group A2 of FIG. 1.

R1 indicates a gate voltage waveform of the first red pixel R connected to the data line D2 and the second gate line.

R2 indicates a gate voltage waveform of the second red pixel R connected to the data line D2 and the third gate line.

R3 indicates a gate voltage waveform of the third red pixel R connected to the data line D2 and the fifth gate line.

R4 indicates a gate voltage waveform of the fourth red pixel R connected to the data line D2 and the eighth gate line.

B1 indicates a gate voltage waveform of the first blue pixel B connected to the data line D2 and the first gate line.

B2 indicates a gate voltage waveform of the second blue pixel B connected to the data line D2 and the fourth gate line.

B3 indicates a gate voltage waveform of the third blue pixel B connected to the data line D2 and the sixth gate line.

B4 indicates a gate voltage waveform of the fourth blue pixel B connected to the data line D2 and the seventh gate line.

Referring to FIG. 3, the first polarity data voltage is applied during a pre-charging period of the blue pixel B1, and a second polarity data voltage is applied during a main charging period thereof. Only the first polarity data voltage is applied during a pre-charging period and a main charging period of the blue pixel B2. Only the second polarity data voltage is applied during a pre-charging period and the first polarity data voltage of the blue pixel B3. The second polarity data voltage is applied during a pre-charging period of the blue pixel B4, and the first polarity data voltage is applied during a main charging period thereof.

Referring to FIG. 3, only the second polarity data voltage is applied during a pre-charging period and a main charging period of the red pixel R1. The second polarity data voltage is applied during a pre-charging period of the red pixel R2, and the first polarity data voltage is applied during a main charging period thereof. The first polarity data voltage is applied during a pre-charging period of the red pixel R3 and the second polarity data voltage is applied during a main charging period thereof. Only the first polarity data voltage is applied during a pre-charging period and a main charging period of the red pixel R4.

Herein, when the first polarity is a negative (−) polarity, the second polarity is a positive (+) polarity. When the first polarity is the positive (+) polarity, the second polarity is the negative (−) polarity. In one embodiment, the polarity of the data voltage applied during the pre-charging period is opposite to the polarity of the data voltage applied during the main charging period.

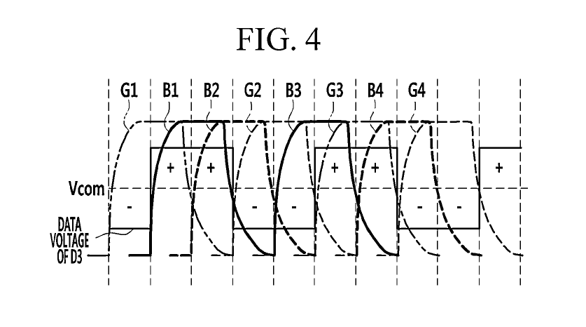

FIG. 4 is a graph showing a data voltage and a gate voltage at a group A3 of FIG. 1.

B1 indicates a gate voltage waveform of the first blue pixel B connected to the data line D3 and the second gate line.

B2 indicates a gate voltage waveform of the second blue pixel B connected to the data line D3 and the third gate line.

B3 indicates a gate voltage waveform of the third blue pixel B connected to the data line D3 and the fifth gate line.

B4 indicates a gate voltage waveform of the fourth blue pixel B connected to the data line D3 and the eighth gate line.

G1 indicates a gate voltage waveform of the first green pixel G connected to the data line D3 and the first gate line.

G2 indicates a gate voltage waveform of the second green pixel G connected to the data line D3 and the fourth gate line.

G3 indicates a gate voltage waveform of the third green pixel G connected to the data line D3 and the sixth gate line.

G4 indicates a gate voltage waveform of the fourth green pixel G connected to the data line D3 and the seventh gate line.

Referring to FIG. 4, only the first polarity data voltage is applied during a pre-charging period and a main charging period of the blue pixel B1. The first polarity data voltage is applied during a pre-charging period of the blue pixel B2, and the second polarity data voltage is applied during a main charging period thereof. The second polarity data voltage is applied during a pre-charging period of the blue pixel B3, and the first polarity data voltage is applied during a main charging period thereof. The first polarity data voltage is applied during a pre-charging period of the blue pixel B4, and the second polarity data voltage is applied during a main charging period thereof.

Referring to FIG. 4, the second polarity data voltage is applied during a pre-charging period of the green pixel G1, and the first polarity data voltage is applied during a main charging period thereof. Only the second polarity data voltage is applied during a pre-charging period and a main charging period of the green pixel G2. Only the first polarity data voltage is applied during a pre-charging period and a main charging period of the green pixel G3. Only the second polarity data voltage is applied during a pre-charging period and a main charging period of the green pixel G4.

Herein, when the first polarity is a negative (−) polarity, the second polarity is a positive (+) polarity. When the first polarity is the positive (+) polarity, the second polarity is the negative (−) polarity. In one embodiment the polarity of the data voltage applied during the pre-charging period is opposite to the polarity of the data voltage applied during the main charging period.

Summarizing the descriptions made with reference to FIG. 1 to FIG. 4, different polarity data voltages are respectively applied during the pre-charging period and the main charging period of a first half of red pixels of all the red pixels R.

The same polarity data voltages are applied during the pre-charging period and the main charging period of a second half of red pixels of all the red pixels R.

When a group of the first half of red pixels R to which the different polarity data voltages are respectively applied during the pre-charging period and the main charging period is referred to as a first red pixel group and a group of the second half of red pixels R to which the same polarity data voltages are applied during the pre-charging period and the main charging period is referred to as a second red pixel group, the first red pixel group is brighter than the second red pixel group. For example, the red pixels for which the same polarity data voltage is applied for both the pre-charging period and the main charging period are dimmer.

Different polarity data voltages are respectively applied during the pre-charging period and the main charging period of a first half of green pixels of all the green pixels G. The same polarity data voltages are applied during the pre-charging period and the main charging period of a second half of green pixels of all the green pixels G.

When a group of the first half of green pixels G to which the different polarity data voltages are respectively applied during the pre-charging period and the main charging period is referred to as a first green pixel group and a group of the second half of green pixels G to which the same polarity data voltages are applied during the pre-charging period and the main charging period is referred to as a second green pixel group, the first green pixel group is brighter than the second green pixel group. For example, the green pixels for which the same polarity data voltage is applied for both the pre-charging period and the main charging period are dimmer.

Different polarity data voltages are respectively applied during the pre-charging period and the main charging period of a first half of blue pixels of all the blue pixels B. The same polarity data voltages are applied during the pre-charging period and the main charging period of a second half of blue pixels of all the blue pixels B.

When a group of the first half of blue pixels B to which the different polarity data voltages are respectively applied during the pre-charging period and the main charging period is referred to as a first blue pixel group and a group of the second half of blue pixels B to which the same polarity data voltages are applied during the pre-charging period and the main charging period is referred to as a second blue pixel group, the first blue pixel group is brighter than the second blue pixel group. For example, the blue pixels for which the same polarity data voltage is applied for both the pre-charging period and the main charging period are dimmer.

In the present embodiment, the number of the red pixels R included in the first red pixel group, the number of the green pixels G included in the first green pixel group, and the number of the blue pixels B included in the first blue pixel group are the same.

In the present embodiment, the number of the red pixels R included in the second red pixel group, the number of the green pixels G included in the second green pixel group, and the number of the blue pixels B included in the second blue pixel group are the same.

Accordingly, when the display panels are entirely viewed, the red pixels R, the green pixels G, and the blue pixels B have the same brightness. As a result, in accordance with the present example embodiment, it is possible to remove a purplish phenomenon, in which the red pixels R and the blue pixels B appear brighter than the green pixels G. Further, the purplish phenomenon may occur in a low temperature environment (10° C. or lower) in which driving performance of the thin film transistors may be deteriorated. The purplish phenomenon may be less likely to occur in a room temperature environment.

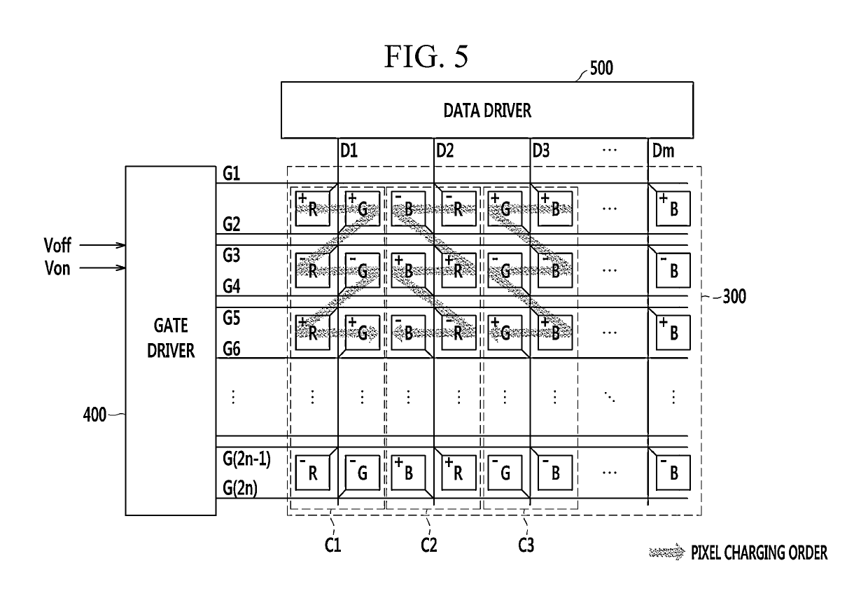

FIG. 5 is a block diagram showing a display device including a thin film transistor array panel in accordance with a comparative embodiment.

The thin film transistor array panel in accordance with the comparative embodiment is similar to the thin film transistor array panel shown in FIG. 1, except for a connection relationship between each pixel R, G, and B and the gate lines G1, G3, . . . , and G(2n−1). Accordingly, the same description thereof will be omitted.

As shown in FIG. 5, one of the data lines D1-Dm is disposed per two pixel columns in the thin film transistor array panel in accordance with the comparative embodiment. Specifically, one data line is disposed between a pair of pixel columns, the pixels R, G, and B of odd-numbered pixel columns are connected to the data lines D1-Dm directly neighboring at the right side through the switching element, and the pixels R, G, and B of the even-numbered pixel columns are connected to the data lines D1-Dm directly neighboring at the left side through the switching element.

All the red pixels R are connected to the gate lines G1, G3, . . . , and G(2n−1) disposed at an upper side thereof, and are connected to the data lines D1-Dm disposed at different sides when only the red pixels R which are adjacently located in a row direction are viewed. For example, the red pixel R to be connected to the first data line D1 is connected to the data line D1 disposed at a right side thereof, while the red pixel R to be connected to the second data line D2 is connected to the data line D2 disposed at a left side thereof.

In contrast, all the green pixels G are connected to the gate lines G2, G4, . . . , and G(2n) disposed at a lower side thereof, and are connected to the data lines D1-Dm disposed at different sides when only the green pixels G which are adjacently located in the row direction are viewed.

All the blue pixels B are alternately connected to the gate lines G1-G(2n) disposed at the upper side and the lower side thereof, and are connected to the data lines D1-Dm disposed at different sides when only the blue pixels B which are adjacently located in the row direction are viewed.

As a result, when the respective pixels R, G, and B are represented in a matrix form, the thin film transistor array panel of the comparative embodiment has a structure in which pixel units (inversion driving units) of a 6×1 size are repeated.

The connection relationship between the pixels R, G, and B disposed on the same pixel column and the gate lines G1-G(2n) and data lines D1-Dm may be the same.

Hereinafter, in the comparative embodiment, the pixel columns connected to the data lines D1, D2, and D3 of the thin film transistor array panel are respectively referred to as a group C1, a group C2, and a group C3.

The charging of each pixel at C1 is performed in the order of a first red pixel of the red pixel column connected to the data line D1, a first green pixel G of the green pixel column connected to the data line D1, a second red pixel R of the red pixel column connected to the data line D1, and a second green pixel G of the green pixel column connected to the data line D1. The pixels are alternately charged in the order of the red pixel R, the green pixel G, and the red pixel R. In this order, the last pixel connected to the data line D1 is charged.

The charging of each pixel at C2 is performed in the order of a first red pixel R of the red pixel column connected to the data line D2, a first blue pixel B of the blue pixel column connected to the data line D2, a second red pixel R of the red pixel column connected to the data line D2, and a second blue pixel B of the blue pixel column connected to the data line D2. The pixels are alternately charged in the order of the red pixel R, the blue pixel B, and the red pixel R. In this order, the last pixel connected to the data line D2 is charged.

The charging of each pixel at C3 is performed in the order of a first blue pixel B of the blue pixel column connected to the data line D3, a first green pixel G of the green pixel column connected to the data line D3, a second blue pixel B of the blue pixel column connected to the data line D3, and a second green pixel G of the green pixel column connected to the data line D3. The pixels are alternately charged in the order of the blue pixel B, the pixel G, and the blue pixel B. In this order, the last pixel connected to the data line D3 is charged.

The connection relationship below the R, G, and B pixels and display signal lines G1-G(2n) and D1-Dm illustrated in FIG. 5 is only an example, and the connection relationship and disposition may be changed.

Next, an effect of the thin film transistor array panel in accordance with the example embodiment will be described with reference to FIG. 1 to FIG. 10.

First, returning to FIGS. 5 through 9, a pixel charging process in accordance with the comparative embodiment will be described.

Referring to FIG. 5, a data voltage of the comparative embodiment has a positive (+) polarity and a negative (−) polarity. In accordance with the comparative embodiment, when the data voltage is applied to the red pixel R connected to the data line D1, the data voltage alternates between the positive polarity and the negative polarity from a first row thereof. When the data voltage is applied to the green pixel G connected to the data line D1, the data voltage alternates between the negative polarity and the positive polarity from the first row thereof.

When the data voltage is applied to the blue pixel B connected to the data line D2, the data voltage alternates between the positive polarity and the negative polarity from the first row thereof. When the data voltage is applied to the red pixel R connected to the data line D2, the data voltage alternates between the negative polarity and the positive polarity from the first row thereof.

As a result, when the data voltage is applied to the pixels disposed in front of each data line D1-Dm (e.g., left side of the data line in FIG. 5), the data voltage alternates between the positive polarity and the negative polarity from the first row thereof. When the data voltage is applied to the pixels disposed in back of each data line D1-Dm (e.g., right side of the data line in FIG. 5), the data voltage alternates between the negative polarity and the positive polarity from the first row thereof.

Referring to FIG. 5, the polarity of the data voltage inputted into each pixel has the first polarity for two units of time and to the second polarity for two units of time alternately according to the order in which the pixels are charged.

In accordance with the comparative embodiment, a period during which the gate voltage corresponding to each pixel R, G, and B is applied includes a pre-charging period and a main charging period. The pre-charging period is a period during which the gate voltage is applied to a present pixel while a pixel different from the present pixel is charged. In accordance with the comparative embodiment, the pre-charging period is a period during which the gate voltage is applied to the present pixel while a pixel is charged immediately before the present pixel is charged. The main charging period is a period during which the present pixel is charged. As a result, in accordance with the comparative embodiment, the gate voltage is applied to each pixel R, G, and B from a point in time when a pixel is charged immediately before the present pixel is charged to a point in time when the present pixel is charged.

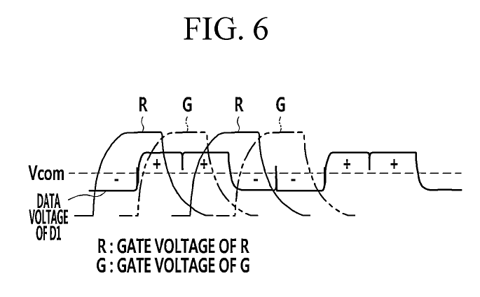

FIG. 6 is a graph showing a data voltage and a gate voltage at a group C1 of FIG. 5.

Referring to FIG. 6, a negative polarity data voltage is applied during a pre-charging period of a red pixel R (e.g., for one unit of time), and a positive polarity data voltage is applied during a main charging period thereof (e.g., for one unit of time). The positive polarity data voltage is applied during a pre-charging period of a next red pixel R (e.g., for one unit of time), and the negative polarity data voltage is applied during a main charging period thereof (e.g., for one unit of time). As a result, the polarity of the data voltage applied during the pre-charging period is opposite to the polarity of the data voltage applied during the main charging period.

For a green pixel G, the polarity of the data voltage applied during the pre-charging period is same as the polarity of the data voltage applied during the main charging period. In other words, the positive polarity data voltage is applied during the pre-charging period of the green pixel G, and the positive polarity data voltage is applied during a main charging period thereof. In the next green pixel G shown in FIG. 6, the negative polarity data voltage is applied during a pre-charging period of a next green pixel G, and the negative polarity data voltage is applied during a main charging period thereof.

Accordingly, the data voltage applied to the red pixels R is changed from a first polarity to a second polarity while the gate-on voltage is applied. Herein, when the first polarity is a negative (−) polarity, the second polarity is a positive (+) polarity. When the first polarity is the positive (+) polarity, the second polarity is the negative (−) polarity. In the red pixels R, a voltage variation of the pixel electrode, which depends on the data voltage, is increased. As a result, while the gate-on voltage is applied, the voltage of a pixel electrode may not reach a desired voltage level and a liquid crystal capacitor of the red pixel R may be insufficiently charged.

In contrast, the data voltage applied to the green pixels has the same polarity while the gate-on voltage is applied. As a result, while the gate-on voltage is applied, the voltage of the pixel electrode reaches the desired voltage level and the liquid crystal capacitor of the red pixel R is sufficiently charged.

Accordingly, the red pixels R connected to the data line D1 are brighter than the green pixels G.

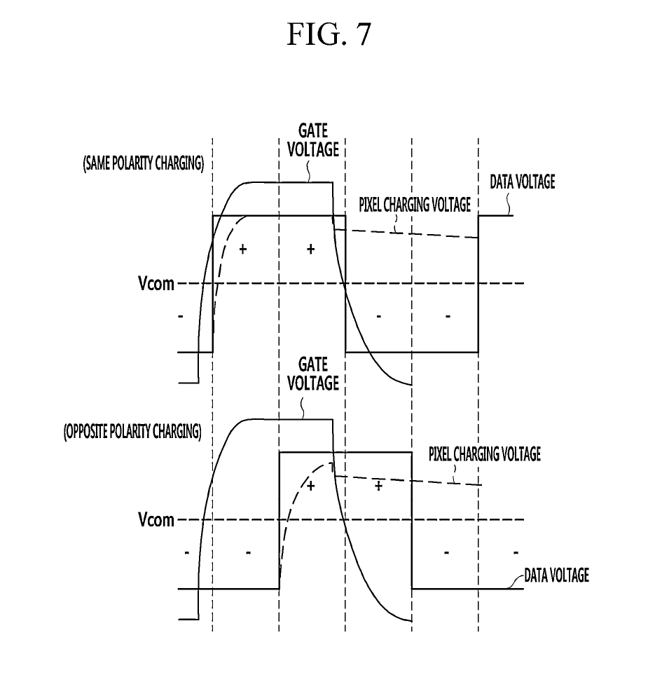

FIG. 7 shows a charging amount of a liquid crystal capacitor of each pixel according to a data voltage polarity while a gate-on voltage is applied.

As shown in FIG. 7, when the data voltage applied to the pixel is maintained to have the same polarity while the gate-on voltage is applied, the liquid crystal capacitor of the pixel is sufficiently charged.

When the data voltage applied to the pixel is changed from the first polarity to the second polarity while the gate-on voltage is applied, the liquid crystal capacitor of the pixel may be insufficiently charged. Herein, when the first polarity is a negative (−) polarity, the second polarity is a positive (+) polarity. When the first polarity is the positive (+) polarity, the second polarity is the negative (−) polarity.

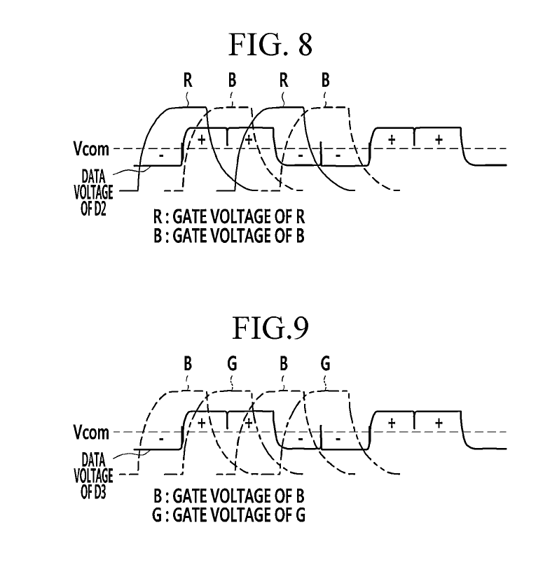

FIG. 8 is a graph showing a data voltage and a gate voltage at a group C2 of FIG. 5.

Referring to FIG. 8, a negative polarity data voltage is applied during a pre-charging period of a red pixel R, and a positive polarity data voltage is applied during a main charging period thereof. The positive polarity data voltage is applied during a pre-charging period of a next red pixel R, and the negative polarity data voltage is applied during a main charging period thereof. As a result, the polarity of the data voltage applied during the pre-charging period is opposite to the polarity of the data voltage applied during the main charging period.

For a blue pixel B, the polarity of the data voltage applied during the pre-charging period is the same as the polarity of the data voltage applied during the main charging period. In other words, the positive polarity data voltage is applied during both the pre-charging period and the main charging period of the blue pixel B. Similarly, the negative polarity data voltage is applied during both the pre-charging period and the main charging period of the next blue pixel B.

Accordingly, the data voltage applied to the red pixels R is changed from a first polarity to a second polarity while the gate-on voltage is applied. Herein, when the first polarity is a negative (−) polarity, the second polarity is a positive (+) polarity. When the first polarity is the positive (+) polarity, the second polarity is the negative (−) polarity. A voltage variation of the pixel electrode, which depends on the data voltage, is increased. As a result, while the gate-on voltage is applied, the voltage of a pixel electrode may not reach a desired voltage level and a liquid crystal capacitor of the red pixel R may be insufficiently charged.

In contrast, the data voltage applied to the blue pixels B has the same polarity while the gate-on voltage is applied. As a result, while the gate-on voltage is applied, the voltage of the pixel electrode reaches the desired voltage level and the liquid crystal capacitor of the blue pixel B is sufficiently charged.

Accordingly, the red pixels R connected to the data line D2 is brighter than the blue pixels B.

FIG. 9 is a graph showing a data voltage and a gate voltage at a group C3 of FIG. 5.

Referring to FIG. 8, a negative polarity data voltage is applied during a pre-charging period of a blue pixel B one time, and a positive polarity data voltage is applied during a main charging period thereof one time. The positive polarity data voltage is applied during a pre-charging period of a next blue pixel R one time, and the negative polarity data voltage is applied during a main charging period thereof one time. As a result, the polarity of the data voltage applied during the pre-charging period is opposite to the polarity of the data voltage applied during the main charging period.

For a green pixel G, the polarity of the data voltage applied during the pre-charging period is opposite to the polarity of the data voltage applied during the main charging period. In other words, the positive polarity data voltage is applied during the pre-charging period of the green pixel G one time, and the positive polarity data voltage is applied during a main charging period thereof one time. The negative polarity data voltage is applied during a pre-charging period of a next green pixel G one time, and the negative polarity data voltage is applied during a main charging period thereof one time.

Accordingly, the data voltage applied to the blue pixel B is changed from a first polarity to a second polarity while the gate-on voltage is applied. Herein, when the first polarity is a negative (−) polarity, the second polarity is a positive (+) polarity. When the first polarity is the positive (+) polarity, the second polarity is the negative (−) polarity. A voltage variation of the pixel electrode changed depending on the data voltage is increased. As a result, while the gate-on voltage is applied, the voltage of a pixel electrode may not reach a desired voltage level and a liquid crystal capacitor of the blue pixel B may be insufficiently charged.

In contrast, the data voltage applied to the green pixels G has the same polarity while the gate-on voltage is applied. As a result, while the gate-on voltage is applied, the voltage of the pixel electrode reaches the desired voltage level and the liquid crystal capacitor of the green pixel G is sufficiently charged.

Accordingly, the blue pixels B connected to the data line D3 is brighter than the green pixels G.

As a result, when the pixels R, G, and B connected to the data lines D1, D2, and D3, the red pixels R are brighter than the blue pixels B, and the blue pixels B are brighter than the green pixels G. Accordingly, a purplish phenomenon by which the red pixels R and the blue pixels B are relatively brighter than the green pixels G is generated.

Hereinafter, a method for removing vertical line blurs in accordance with the example embodiment will be described with reference to FIG. 1 and FIG. 5.

In FIG. 1 and FIG. 5, a data voltage of the pixel connected to the first gate line is affected by a first kick-back voltage when a gate-off voltage Voff is applied to a first gate line and is affected by a second kick-back voltage when the gate-off voltage Voff is applied to a second gate line that is adjacent to the first gate line in the pixel column direction.

The data voltage of the pixel and the second gate line are affected by the second kick-back voltage when the gate-off voltage Voff is applied to the second gate line.

As a result, the data voltage of the pixel connected to the first gate line is affected by the kick-back voltage two times. However, the data voltage of the pixel connected to the second gate line is affected by the kick-back voltage one time.

In the comparative embodiment, the first gate line may be an upper gate line connected to each pixel. Further, the second gate line may be a lower gate line connected to each pixel. Hereinafter, the first gate line and the second gate line are respectively assumed to the upper gate line and the lower gate line connected to each pixel, for example.

The thin film transistor array panel in accordance with the example embodiment will be described with reference to FIG. 1. A first half of all the red pixels R are connected to the first gate line, and a second half thereof are connected to the second gate line. A first half of all the green pixels G are connected to the first gate line, and a second half thereof are connected to the second gate line. A first half of all the blue pixels B are connected to the first gate line, and a second half thereof are connected to the second gate line.

Accordingly, the first half of all the red pixels R are affected by the kick-back voltage two times, and the second half thereof are affected by the kick-back voltage one time. The first half of all the green pixels G are affected by the kick-back voltage two times, and the second half thereof are affected by the kick-back voltage one time. The first half of all the blue pixels B are affected by the kick-back voltage two times, and the second half thereof are affected by the kick-back voltage one time.

As a result, the effect of the kick-back voltage on each of the red, green, and blue pixels R, G, and B is the same. Thus, in the present embodiment, no deviation in luminance is generated.

The thin film transistor array panel in accordance with the comparative embodiment will be now described with reference to FIG. 5. All the red pixels R are connected to the first gate line. Accordingly, all the red pixels R are affected by the kick-back voltage two times. All the green pixels G are connected to the first gate line. Accordingly, all the green pixels G are affected by the kick-back voltage two times. A first half of all the blue pixels B are connected to the first gate line, and a second half thereof are connected to the second gate line. Accordingly, the first half of all the blue pixels B are affected by the kick-back voltage two times, and the second half thereof are affected by the kick-back voltage one time. As a result, the deviation in luminance is generated depending on the extent to which the red, green, and blue pixels R, G, and B are affected by the kick-back voltage. The deviation in luminance may generated vertical line blurs.

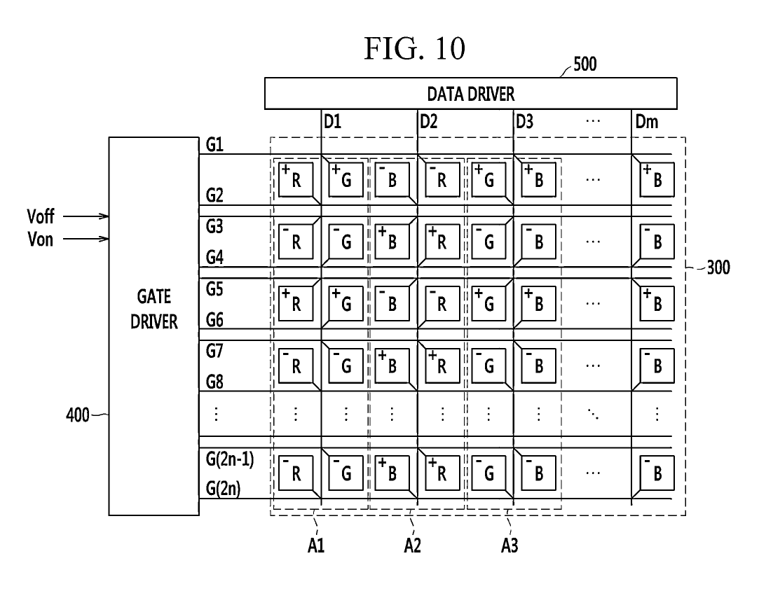

FIG. 10 is a block diagram showing a display device including a thin film transistor array panel in accordance with yet another example embodiment.

The device including the thin film transistor array panel in accordance with the present example embodiment will be described with reference to FIG. 10.

The device including the thin film transistor array panel in accordance with the present example embodiment is similar to the display device including the thin film transistor array panel shown in FIG. 1 except for a connection relationship between each pixel R, G, and B and the gate lines G1, G3, . . . , and G(2n−1). Accordingly, the same description thereof will be omitted.

One of the data lines D1-Dm is disposed per two pixel columns in the thin film transistor array panel in accordance with the comparative embodiment. Specifically, one data line is disposed between a pair of pixel columns, the pixels R, G, and B of odd-numbered pixel columns are connected to the data lines D1-Dm directly neighboring at the right side thereof through the switching element, and the pixels R, G, and B of the even-numbered pixel columns are connected to the data lines D1-Dm directly neighboring at the left side thereof through the switching element.

A first red pixel R of the red pixel columns connected to the data line D1 is connected to the gate line G2 disposed at the lower side thereof, and a second red pixel R is connected to the gate line G3 disposed at the upper side thereof. A third red pixel R is connected to the gate line G5 disposed at the upper side thereof, and a fourth red pixel R is connected to the gate line G8 disposed at the lower side thereof. In this way, an n^{th} red pixel R is connected to the corresponding gate line.

A first green pixel G of the green pixel columns connected to the data line D1 is connected to the gate line G1 disposed at the upper side thereof, and a second green pixel G is connected to the gate line G4 disposed at the lower side thereof. A third green pixel G is connected to the gate line G6 disposed at the lower side, thereof and a fourth green pixel G is connected to the gate line G7 disposed at the upper side thereof. In this way, an n^{th} green pixel G is connected to the corresponding gate line.

A first blue pixel B of the blue pixel columns connected to the data line D2 is connected to the gate line G2 disposed at the lower side thereof, and a second blue pixel R is connected to the gate line G3 disposed at the upper side thereof. A third blue pixel B is connected to the gate line G5 disposed at the upper side thereof, and a fourth blue pixel B is connected to the gate line G8 disposed at the lower side thereof. In this way, an n^{th} blue pixel B is connected to the corresponding gate line.

A first red pixel R of the red pixel columns connected to the data line D2 is connected to the gate line G1 disposed at the upper side thereof, and a second red pixel R is connected to the gate line G4 disposed at the lower side thereof. A third red pixel R is connected to the gate line G6 disposed at the lower side thereof, and a fourth red pixel R is connected to the gate line G7 disposed at the upper side thereof. In this way, an n^{th} red pixel R is connected to the corresponding gate line.

A first green pixel G of the green pixel columns connected to the data line D3 is connected to the gate line G2 disposed at the lower side thereof, and a second green pixel G is connected to the gate line G3 disposed at the upper side thereof. A third green pixel G is connected to the gate line G5 disposed at the upper side thereof, and a fourth green pixel G is connected to the gate line G8 disposed at the lower side thereof. In this way, an n^{th} blue pixel B is connected to the corresponding gate line.

A first blue pixel B of the green pixel columns connected to the data line D3 is connected to the gate line G1 disposed at the upper side thereof, and a second blue pixel B is connected to the gate line G4 disposed at the lower side thereof. A third blue pixel B is connected to the gate line G6 disposed at the lower side thereof, and a fourth blue pixel B is connected to the gate line G7 disposed at the upper side thereof. In this way, an n^{th} blue pixel B is connected to the corresponding gate line.

As a result, a first pixel of a front pixel column (e.g., left side of the data line D1 in FIG. 10) is connected to the gate line disposed at the lower side, and a second pixel thereof is connected to the gate line disposed at the upper side. A third pixel thereof is connected to the gate line disposed at the upper side, and a fourth pixel is connected to the gate line disposed at the lower side.

Further, a first pixel of a back pixel column (e.g., right side of the data line D1 in FIG. 10) is connected to the gate line disposed at the upper side, and a second pixel thereof is connected to the gate line disposed at the lower side. A third pixel thereof is connected to the gate line disposed at the lower side, and a fourth pixel is connected to the gate line disposed at the upper side.

The gate driver 400 included in the display device in accordance with the present embodiment is connected to the gate lines G1-G(2n) of the display panel 300 to apply a gate signal consisting of a combination of a gate-on voltage Von for turning on the switching element and a gate-off voltage Voff for turning off the switching element to the gate lines G1-G(2n). Further, the gate driver 400 in accordance with the present example embodiment may group the gate lines G1-G(2n) in one unit of four gate lines and apply gate signals in the order of the second gate line, the first gate line, the fourth gate line, and the third gate line. In other words, the gate driver 400 of the present example embodiment may apply the gate signals in the order of G2, G1, G4, G3, G6, G5, G8, G7, . . . , G(2n−1), G(2n−3), G(2n), and G(2n−2). As the gate lines are charged in the order described above, the charging order of the pixels R, G, and B in the display device of the example embodiment is the same as that of the pixels R, G, and B in the display device shown in FIG. 1.

The thin film transistor array panels according to various example embodiments may be applied to various kinds of display devices in addition to the liquid crystal display.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A thin film transistor array panel comprising:
an array of pixels comprising a plurality of pixel columns and a plurality of pixel rows, the plurality of pixel columns comprising a first pixel column and a second pixel column that is adjacent to the first pixel column, and the plurality of pixel rows comprising a first pixel row and a second pixel row that is adjacent to the first pixel row;
a plurality of gate lines configured to transfer a gate signal to the pixels, two of the plurality of gate lines disposed at both sides of each of the plurality of pixel rows and extending in a row direction, respectively; and
a plurality of data lines configured to transfer a data signal to the pixels, each of the plurality of data lines disposed between two of the plurality of pixel columns that are adjacent to each other,
wherein pixels in the same pixel column are configured to output the same color, and
wherein the pixels of the first and second pixel columns are connected to a first one of the plurality of data lines such that a data signal is applied to the pixels of the first and second pixel columns through the first data line, and that, in the first pixel row, the data signal is applied to the pixel of the first pixel column prior to the pixel of the second pixel column, whereas, in the second pixel row, the data signal is applied to the pixel of the second pixel column prior to the pixel of the first pixel column.

2. The thin film transistor array panel of claim 1, wherein the plurality of pixel rows further comprises a third pixel row that is adjacent to the second pixel row and a fourth pixel row that is adjacent to the third pixel row, and wherein, in the third pixel row, the data signal is applied to the pixel of the second pixel column prior to the pixel of the first pixel column, whereas, in the fourth pixel row, the data signal is applied to the pixel of the first pixel column prior to the pixel of the second pixel column.

3. The thin film transistor array panel of claim 1, wherein each of the first and second pixel columns comprises first, second, third, and fourth pixels that are sequentially arranged therein, respectively,
wherein the first pixel of the first pixel column is connected to a gate line disposed at a side that faces away from the second pixel of the first pixel column, the second pixel of the first pixel column is connected to a gate line disposed at a side that faces the third pixel of the first pixel column, the third pixel of the first pixel column is connected to a gate line disposed at a side that faces the fourth pixel of the first pixel column, and the fourth pixel of the first pixel column is connected to a gate line disposed at a side that faces the third pixel of the first pixel column, and
wherein the first pixel of the second pixel column is connected to a gate line disposed at a side that faces the second pixel of the second pixel column, the second pixel of the second pixel column is connected to a gate line disposed at a side that faces the first pixel of the second pixel column, the third pixel of the second pixel column is connected to a gate line disposed at a side that faces the second pixel of the second pixel column, and the fourth pixel of the second pixel column is connected to a gate line disposed at a side that faces away from the third pixel of the second pixel column.

4. The thin film transistor array panel of claim 1, wherein each of the plurality of pixel rows comprises a sequence of red, green, and blue pixels that are repeated.

5. The thin film transistor array panel of claim 1, wherein a gate voltage is sequentially applied to the pairs of gate lines from an end of the array that is closer from the first pixel row than the second pixel row to the other end of the array that is closer from the second pixel row than the first pixel row.

6. The thin film transistor array panel of claim 5, wherein the data voltage starts at a first polarity and alternates between the first polarity and a second polarity while it is applied to the pixel columns connected to the first data line, and the data voltage starts at the second polarity and alternates between the second polarity and the first polarity while it is applied to the pixel columns connected to a second data line that is adjacent to the first data line.

7. The thin film transistor array panel of claim 6, wherein the first polarity is opposite to the second polarity.

8. The thin film transistor array panel of claim 4, wherein the first pixel column is disposed at a right side of the first data line.

9. The thin film transistor array panel of claim 1, wherein the plurality of gate lines comprise first, second, third, and fourth gate lines sequentially ordered in the pixel column direction, and wherein a gate signal is applied to the first, second, third, and fourth gate lines in the following order: the second gate line, the first gate line, the fourth gate line, and the third gate line.

10. The thin film transistor array panel of claim 9, wherein the data signal starts at the first polarity and alternates between the first polarity and a second polarity while it is applied to the pixel columns connected to the first data line, and the data voltage starts at the second polarity and alternates between the second polarity and the first polarity while it is applied to the pixel columns connected to a second data line that is adjacent to the first data line.

11. A display device comprising:
a gate driver configured to generate a gate signal;
a data driver configured to generate a data signal; and
a thin film transistor array panel,
wherein the thin film transistor array panel includes:
an array of pixels comprising a plurality of pixel columns including a plurality of pixels and a plurality of pixel rows, the plurality of pixel columns comprising a first pixel column and a second pixel column that is adjacent to the first pixel column, and the plurality of pixel rows comprising a first pixel row and a second pixel row that is adjacent to the first pixel row;
a plurality of pairs of gate lines configured to transfer a gate signal to the pixels, two of the plurality of gate lines disposed at both sides of each of the plurality of pixel rows and extending in a row direction, respectively; and
a plurality of pairs of data lines configured to transfer a data signal to the pixels, each of the plurality of data lines disposed between two of the plurality of pixel columns that are adjacent to each other,
wherein pixels in the same pixel column are configured to output the same color, and
wherein the pixels of the first and second pixel columns are connected to a first one of the plurality of data lines such that a data signal is applied to the pixels of the first and second pixel columns through the first data line, and that, in the first pixel row, the data signal is applied to the pixel of the first pixel column prior to the pixel of the second pixel column, whereas, in the second pixel row, the data signal is applied to the pixel of the second pixel column prior to the pixel of the first pixel column.

12. The display device of claim 11, wherein the plurality of pixel rows further comprises a third pixel row that is adjacent to the second pixel row and a fourth pixel row that is adjacent to the third pixel row, and wherein, in the third pixel row, the data signal is applied to the pixel of the second pixel column prior to the pixel of the first pixel column, whereas, in the fourth pixel row, the data signal is applied to the pixel of the first pixel column prior to the pixel of the second pixel column.

13. The display device of claim 11, wherein each of the first and second pixel columns comprises first, second, third, and fourth pixels that are sequentially arranged therein, respectively,
wherein the first pixel of the first pixel column is connected to a gate line disposed at a side that faces away from the second pixel of the first pixel column, a second pixel of the first pixel column is connected to a gate line disposed at a side that faces the third pixel of the first pixel column, the third pixel of the first pixel column is connected to a gate line disposed at a side that faces the fourth pixel of the first pixel column, and the fourth pixel of the first pixel column is connected to a gate line disposed at a side that faces the third pixel of the first pixel column, and
wherein the first pixel of the second pixel column is connected to a gate line disposed at a side that faces the second pixel of the second pixel column, the second pixel of the second pixel column is connected to a gate line disposed at a side that faces the first pixel of the second pixel column, the third pixel of the second pixel column is connected to a gate line disposed at a side that faces the second pixel of the second pixel column, and the fourth pixel of the second pixel column is connected to a gate line disposed at a side that faces away from the third pixel of the second pixel column.

14. The display device of claim 11, wherein each of the plurality of pixel rows comprises a sequence of red, green, and blue pixels that are repeated.

15. The display device of claim 11, wherein a gate voltage is sequentially applied to the pairs of gate lines from an end of the array that is closer from the first pixel row than the second pixel row to the other end of the array that is closer from the second pixel row than the first pixel row.

16. The display device of claim 15, wherein the data voltage starts at a first polarity and alternates between the first polarity and a second polarity while it is applied to the pixel columns connected to the first data line, and the data voltage starts at the second polarity and alternates between the second polarity and the first polarity while it is applied to the pixel columns connected to a second data line that is adjacent to the first data line.

17. The display device of claim 16, wherein the first polarity is opposite to the second polarity.

18. The display device of claim 13, wherein the first pixel column is disposed at a right side of the first data line.

19. The display device of claim 11, wherein the plurality of gate lines comprise first, second, third, and fourth gate lines sequentially ordered in the pixel column direction, and wherein a gate signal is applied to the first, second, third, and fourth gate lines in the following order: the second gate line, the first gate line, the fourth gate line, and the third gate line.

20. The display device of claim 19, wherein the data signal starts at the first polarity and alternates between the first polarity and a second polarity while it is applied to the pixel columns connected to the first data line, and the data voltage alternately has the second polarity and the first polarity while it is applied to the pixel columns connected to a second data line that is adjacent to the first data line.
